(19) United States
(12) Patent Application Publication
(10) Pub. No.: US 2021/0283937 A1
(43) Pub. Date: Sep. 16, 2021

(54) INKJET PRINTING METHOD, CURABLE COMPOSITION, INK, STORED CONTAINER, AND TWO-DIMENSIONAL OR THREE-DIMENSIONAL IMAGE FORMING APPARATUS

(71) Applicant: Hidetoshi FUJII, Kanagawa (JP)

(72) Inventor: Hidetoshi FUJII, Kanagawa (JP)

(73) Assignee: Ricoh Company, Ltd., Tokyo (JP)

(21) Appl. No.: 17/185,755

(22) Filed: Feb. 25, 2021

(30) Foreign Application Priority Data
Mar. 13, 2020 (JP) 2020-043985
Jan. 29, 2021 (JP) 2021-013498

(51) Int. Cl. B41M 7/00; B33Y 30/00; B29C 64/255; B29C 64/264; B41M 5/00; B41J 11/00; B41J 2/175; C09D 11/107

(52) U.S. Cl. CPC B41M 7/0081; B33Y 30/00; B29C 64/255; B29C 64/264; B29K 2079/00; B41J 11/00214; B41J 2/175; C09D 11/107; B41M 5/0023

(57) ABSTRACT

An inkjet printing method is provided that includes irradiating a curable composition with ultraviolet rays emitted from a light-emitting diode having a peak illuminance in a wavelength range of from 265 nm through 300 nm to cure the curable composition. The curable composition contains water, a polymerizable compound, and a water-soluble polymerization initiator having local absorption maximum in a wavelength range of 300 nm or shorter. A mass content of the water is higher than a mass content of the polymerizable compound and the mass content of the polymerizable compound is higher than a mass content of the water-soluble polymerization initiator.

### CROSS-REFERENCE TO RELATED APPLICATIONS

This patent application is based on and claims priority pursuant to 35 U.S.C. § 119(a) to Japanese Patent Application No. 2020-043985, filed on Mar. 13, 2020 and Japanese Patent Application No. 2021-013498, filed on Jan. 29, 2021, in the Japan Patent Office, the entire disclosure of which is hereby incorporated by reference herein.

### BACKGROUND

### Technical Field

The present disclosure relates to an inkjet printing method, a curable composition, an ink, a stored container, and a two-dimensional or three-dimensional image forming apparatus.

### Description of the Related Art

In recent years, inkjet printing methods have been spreading rapidly because inkjet printing methods can print color images easily and have low running costs.

As inkjet printing inks, water-based dye inks obtained by dissolving dyes in water-based media, and solvent-based inks obtained by dissolving oil-soluble dyes in organic solvents are used. Generally, from the viewpoints of the environment and safety, inks obtained by dissolving water-soluble dyes in water or in water and water-soluble organic solvents are used in offices and households.

Water-based pigment inks obtained by dispersing pigments having particle shapes in water are paid attention. Inkjet printing inks containing water-dispersible pigments are known to be excellent in water resistance and light resistance.

A water-based pigment ink proposed recently contains water as a main agent, and contains a radical reactive polymerizable material having an acrylate structure in pan of the structure thereof. Through a radical reaction, this water-based pigment ink can form an ink film having scratch resistance.

### SUMMARY

According to one aspect of the present disclosure, an inkjet printing method includes irradiating a curable composition with ultraviolet rays emitted from a light-emitting diode having a peak illuminance in a wavelength range of from 265 nm through 300 nm to cure the curable composition. The curable composition contains water, a polymerizable compound, and a water-soluble polymerization initiator having local absorption maximum in a wavelength range of 300 nm or shorter. A mass content of the water is higher than a mass content of the polymerizable compound and the mass content of the polymerizable compound is higher than a mass content of the water-soluble polymerization initiator.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example of an image forming apparatus of the present disclosure;

FIG. 2 is a schematic view illustrating an example of another image forming apparatus of the present disclosure; and

FIG. 3A to 3D are schematic views illustrating an example of yet another image forming apparatus of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure can provide an inkjet printing method excellent in dischargeability and impartment of scratch resistance and anti-beading.

Embodiments of the present disclosure will be described below.

An inkjet printing method of the present disclosure includes irradiating a curable composition with ultraviolet rays emitted from a light-emitting diode having a peak illuminance in a wavelength range of from 265 nm through 300 nm to cure the curable composition, wherein the curable composition contains water, a polymerizable compound, and a water-soluble polymerization initiator having local absorption maximum in a wavelength range of 300 nm or shorter, and a mass content of the water is higher than a mass content of the polymerizable compound and the mass content of the polymerizable compound is higher than a mass content of the water-soluble polymerization initiator.

First, the curable composition will be described.

### (Curable Composition)

The curable composition of the present disclosure contains water, a polymerizable compound, and a water-soluble polymerization initiator having local absorption maximum at a wavelength of 300 nm or shorter, and a mass content of the water is higher than a mass content of the polymerizable compound and the mass content of the polymerizable compound is higher than a mass content of the water-soluble polymerization initiator. The curable composition further contains other components as needed.

The present inventors have studied curable compositions that are excellent in dischargeability and impartment of scratch resistance and anti-beading, and obtained the following finding.

For example, existing inks containing water-soluble polymerization initiators have been cured using high-pressure mercury lamps or metal halide lamps because such inks cannot be cured sufficiently using light-emitting diodes (LED). Use of high-pressure mercury lamps or metal halide lamps necessitates large-size equipment and an exhaust gas ventilator, leading to problems such as rise of the internal temperature of the equipment due to heat generation of the lamps.

The present inventors have found it possible to overcome this problem by using a water-soluble polymerization initiator having local absorption maximum in a wavelength range of 300 nm oar shorter, and employing a step of irradiating a curable composition with ultraviolet rays emitted from a light-emitting diode having a peak illuminance in a wavelength range of from 265 nm through 300 nm to cure the curable composition.

### <Polymerizable Compound>

Examples of polymerizable compounds include, but are not limited to, polymerizable monomers containing an acrylate group in a molecule thereof, dimers, and polymer particles containing a polymerizable group. Polymerizable compounds can be polymerized in the presence of radicals.

Examples of polymer particles containing a polymerizable group include, but are not limited to, reactive polyurethane particles. Examples of reactive polyurethane particles include, but are not limited to, (meth)acrylated polyurethane particles.

For example, commercially available products may be used as (meth)acrylated polyurethane particles. Examples of commercially available products include, but are not limited to, UCECOAT (registered trademark) 6558 (available from Daicel-Allnex Ltd.), UCECOAT (registered trademark) 6559 (available from Daicel-Allnex Ltd.), EBECRYL (registered trademark) 2002 (available from Daicel-Allnex Ltd.), EBECRYL (registered trademark) 2003 (available from Daicel-Allnex Ltd.), UCECOAT (registered trademark) 7710 (available from Daicel-Allnex Ltd.), UCECOAT (registered trademark) 7655 (available from Daicel-Allnex Ltd.), NEORADR (registered trademark) 440 (available from Avecia Inc.), NEORADR (registered trademark) 441 (available from Avecia NEORADR (registered trademark) 447 (available from Avecia Inc.), NEORADR (registered trademark) 448 (available from Avecia Inc.), BAYHYDROL (registered trademark) UV2317 (available from Covestro AG), BAYHYDROL (registered trademark) UV VP LS2348 (available from Covestro AG), LUX (registered trademark) 430 (available from Alberding Boley, Inc.), LUX (registered trademark) 399 (available from Alberding Boley, Inc.), LUX (registered trademark) 484 (available from Alberding Boley, Inc.). LAROMER (registered trademark) LR8949, LAROMER (registered trademark) LR8983 (available from BASF GmbH), LAROMER (registered trademark) PE22WN (available from BASF GmbH), LAROMER (registered trademark) PE55WN (available from BASF GmbH), and LAROMER (registered trademark) UA9060 (available from BASF GmbH). Among these commercially available products, LAROMER (registered trademark) LR8949 (available from BASF GmbH), and LAROMER (registered trademark) LR8983 (available from BASF GmbH) are preferable. LAROMER (registered trademark) LR8949 (available from BASF GmbH), and LAROMER (registered trademark) LR8983 (available from BASF GmbH) can improve scratch resistance.

It is preferable to use polymer particles containing a polymerizable group in the form of a dispersion. It is preferable that polymer particles containing a polymerizable group account for from 1% by mass through 10% by mass of the polymerizable compound.

The polymerizable monomer is not particularly limited and may be appropriately selected depending on the intended purpose so long as the polymerizable monomer contains a polymerizable reactive substituent.

As the polymerizable monomer, for example, (meth)acrylate, (meth)acrylamide, and vinyl ether may be used in combination. More specific examples of the polymerizable monomer include, hut are not limited to, ethylene glycol di(meth)acrylate, hydroxypivalic acid neopentyl glycol di(meth)acrylate, γ-butyrolactone acrylate, isobornyl (meth)acrylate, formalized trimethylolpropane mono(meth)acrylate, polytetramethylene glycol di(meth)acrylate, trimethylolpropane (meth)acrylic acid benzoic acid ester, triethylene glycol di(meth)acrylate, tetraethylene glycol di(meth)acrylate, polyethylene glycol diacrylate [CH₂═CH—CO—(OC₂H₄)n-OCOCH═CH₂ (n≈4)], polyethylene glycol diacrylate [CH₂═CH—CO—(OC₂H₄)n-OCOCH═CH₂ (n≈9)], polyethylene glycol diacrylate [CH₂═CH—CO—(OC₂H₄)n-OCOCH═CH₂ (n≈14)], polyethylene glycol diacrylate [CH₂CH—CO—(OC₂H₄)n-OCOCH═CH₂ (n≈23)], dipropylene glycol di(meth)acrylate, tripropylene glycol di(meth)acrylate, polypropylene glycol dimethacrylate [CH₂═C(CH₃)—CO—(OC₃H₆)n-OCOC(CH₃)═CH₂ (n≈7)], 1,3-butanediol di(meth)acrylate, 1,4-butanediol diacrylate, 1,6-hexanediol di(meth)acrylate, 1,9-nonanediol di(meth)acrylate, neopentyl glycol di acrylate, tricyclodecane dimethanol diacrylate, propylene oxide-modified bisphenol A di(meth)acrylate, polyethylene glycol di(meth)acrylate, di pentaerythritol hexa(meth)acrylate, (meth)acryloyhnorpholine, propylene oxide-modified tetramethylolmethane tetra(meth)acrylate, dipentaerythritol hydroxypenta(meth)acrylate, caprolactone-modified dipentaerythritol hydroxypenta(meth)acrylate, ditrimethylolpropane tetra(meth)acrylate, pentaerythritol tetra(meth)acrylate, trimethylolpropane triacrylate, ethylene oxide-modified trimethylolpropane tri(meth)acrylate, propylene oxide-modified trimethylolpropane tri(meth)acrylate, caprolactone-modified trimethylolpropane tri(meth)acrylate, pentaerythritol tri(meth)acrylate, tris(2-hydroxyethyl)isocyanurate tri(meth)acrylate, neopentyl glycol diacrylate, ethoxylated neopentyl glycol di(meth)acrylate, propylene oxide-modified neopentyl glycol di(meta)acrylate, propylene oxide-modified glyceryl tri(meth)acrylate, polyester di(meth)acrylate, polyester tri(meth)acrylate, polyester tetra(meth)acrylate, polyester penta(meth)actylate, polyester poly(meth)acrylate, polyurethane di(meth)acrylate; polyurethane tri(meth)acrylate, polyurethane tetra(meth)acrylate, polyurethane penta(meth)acrylate, polyurethane poly(meth)acrylate, 2-hydroxypropyl (meth)acrylamide, N-vinylcaprolactam, N-vinyl pyrrolidone, N-vinyl formamide, cyclohexane dimethanol monovinyl ether, cyclohexane dimethanol divinyl ether, hydroxyethyl vinyl ether, diethylene glycol monovinyl ether, diethylene glycol divinyl ether, dicyclopentadiene vinyl ether, tricyclodecane vinyl ether, benzyl vinyl ether, and ethyl oxetane methyl vinyl ether. Any of these polymerizable monomers may be selected and added taking into consideration, for example, solubility in water serving as a dispersion medium, composition viscosity, and thickness of a cured film (coating film) on a base material. In terms of solubility in water, acryloylmorpholine, dimethylaminopropyl acrylamide, polyethylene glycol, or polypropylene glycol-modified acrylate are preferable. One of these polymerizable monomers may be used alone or two or more of these polymerizable monomers may be used in combination.

### <Water-Soluble Polymerization Initiator>

The curable composition of the present disclosure contains a water-soluble polymerization initiator having local absorption maximum in a wavelength range of 300 nm or shorter. Water-solubility as used herein refers to solubility of 1 g or greater in water (100 g) at a temperature of 25 degrees C. The water-soluble polymerization initiator produces active species such as a radical or a cation upon application of energy of ultraviolet rays and initiates polymerization of a polymerizable compound (monomer or oligomer).

A photopolymerization initiator containing a hydroxyl group in a molecule thereof is preferable as the water-soluble polymerization initiator. Above all, acetophenone-based, alkylphenone-based, and monoacylphosphine oxide-based water-soluble polymerization initiators are preferable.

As the alkylphenone-based water-soluble polymerization initiator, for example, 2-hydroxy-2-methyl-1-phenylpropanone (OMNIRAD 1173 available from 1GM Resins B.V., with absorption wavelength peaks of 244 nm and 330 nm), and 1-[4-(2-hydroxyethoxyl)-phenyl]-2-hydroxymethyl propanone (OMNIRAD 2959 available from 1GM Resins B.V., with absorption wavelength peaks of 274 nm and 330 nm) are particularly preferable in terms of improving the effects of the present disclosure.

In the present disclosure, local absorption maximum of the water-soluble polymerization initiator can be measured using an ultraviolet and visible spectrophotometer.

In addition, a polymerization accelerator (sensitizer) is optionally used together with the polymerization initiator. The polymerization accelerator is not particularly limited. Preferred examples thereof include, but are not limited to, amines such as trimethylamine, methyl dimethanol amine, triethanol amine, p-diethylamino acetophenone, p-dimethyl amino ethylbenzoate, p-dimethyl amino benzoate-2-ethylhexyl, N,N-dimethyl benzylamine and 4,4′-bis(diethylamino)benzophenone. The content thereof is determined depending on the identity (type) of the polymerization initiator and the content thereof.

### <Water>

The mass content of water in the curable composition has no particular limit and can be suitably selected to suit to a particular application. In terms of the drying property and discharging reliability of the curable composition, the mass content is preferably 50% by mass or more, more preferably from 10% by mass to 90% by mass or less, and much more preferably from 20% by mass to 60% by mass.

The curable composition of the present disclosure contains the water, the polymerizable compound, and the water-soluble polymerization initiator, and a mass content of the water is higher than a mass content of the polymerizable compound and the mass content of the polymerizable compound is higher than a mass content of the water-soluble polymerization initiator. The mass content of the polymerizable compound in the curable composition of the present disclosure is preferably 10% by mass or greater, more preferably from 10% by mass through 40% by mass, and much more preferably from 10% by mass through 20% by mass, in terms of improving the effects of the present disclosure. The mass content of the water-soluble polymerization initiator in the curable composition of the present disclosure is preferably 0.5% by mass or greater and more preferably from 0.5% by mass through 1.0% by mass in terms of improving the effects of the present disclosure.

The ratio between the water-soluble polymerization initiator and the polymerizable compound expressed as a mass ratio of the water-soluble polymerization initiator: the polymerizable compound is from 1:8 through 1:40, and preferably from 1:10 through 1:30. The mass ratio described above is preferable because curability is improved.

The curable composition of the present disclosure may appropriately contain the components described below as needed, in addition to the components described above.

### <Organic Solvent>

There is no specific limitation on the type of the organic solvent used in the present disclosure. For example, water-soluble organic solvents are suitable. Specific examples thereof include, but are not limited to, polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ϵ-caprolactam, and γ-butyrolactone; amides such as formamide, N-methylformamide, N,N-dimethylformamide, 3-methoxy-N,N-dimethyl propionamide, and 3-butoxy-N,N-dimethyl propionamide; amines such as monoethanolamine, di ethanolamine, and triethylamine; sulfur-containing compounds such as dimethyl sulfoxide, sulfolane, and thiodiethanol; propylene carbonate, and ethylene carbonate.

Since the water-soluble organic solvent serves as a humectant and also imparts a good drying property, it is preferable to use an organic solvent having a boiling point of 250 degrees C. or lower.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, diethylene glycol monomethylether, diethyleneglycol monoethylether, diethyleneglycol monobutylether, tetraethyleneglycol monomethylether, and propyleneglycol monoethylether; and polyol aryl ethers such as ethyleneglycol monophenylether and ethyleneglycol monobenzylether.

The polyol compounds having eight or more carbon atoms and glycolether compounds enhance the permeability of ink when paper is used as a print medium.

The content of the organic solvent in the curable composition has no particular limit and can be suitably selected to suit a particular application. In terms of the drying property and discharging reliability of the curable composition, the proportion is preferably from 10 to 60 percent by mass and more preferably from 20 to 60 percent by mass.

### <Colorant>

The curable composition of the present disclosure may contain a colorant. As the colorant, various pigments and dyes may be used that impart black, white, magenta, cyan, yellow, green, orange, and gloss colors such as gold and silver, depending on the intended purpose of the composition and requisite properties thereof. A content of the colorant in the composition is not particularly limited, and may be appropriately determined considering, for example, a desired color density and dispersibility of the colorant in the composition. However, it is preferably from 0.1% by mass to 20% by mass relative to the total mass (100% by mass) of the composition. Incidentally, the curable composition of the present disclosure does not necessarily contain a colorant but can be clear and colorless. In such a case, for example, such a clear and colorless composition is good for an overcooling layer to protect an image.

The pigment can be either inorganic or organic, and two or more of the pigments can be used in combination.

Specific examples of the inorganic pigments include, but are not limited to, carbon blacks (C.I. Pigment Black 7) such as furnace black, lamp black, acetylene black, and channel black, iron oxides, and titanium oxides.

Specific examples of the organic pigments include, but are not limited to, azo pigments such as insoluble azo pigments, condensed azo pigments, azo lakes, and chelate azo pigments, polycyclic pigments such as phthalocyanine pigments, perylene pigments, perinone pigments, anthraquinone pigments, quinacridone pigments, dioxane pigments, thioindigo pigments, isoindolinone pigments, and quinofuranone pigments, dye chelates (e.g., basic dye chelates, acid dye chelates), dye lakes (e.g., basic dye lakes, acid dye lakes), nitro pigments, nitroso pigments, aniline black, and daylight fluorescent pigments.

In addition, a dispersant is optionally added to enhance the dispersibility of pigment. The dispersant has no particular limit and can be, for example, polymer dispersants conventionally used to prepare pigment dispersion (material).

The dyes include, for example, acidic dyes, direct dyes, reactive dyes, basic dyes, and combinations thereof.

### <Pigment Dispersion>

The curable composition can be obtained by mixing a pigment with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by dispersing water, pigment, pigment dispersant, and other optional components and adjusting the particle size. It is good to use a dispersing device for dispersion.

The particle diameter of the pigment in the pigment dispersion has no particular limit. For example, the maximum frequency in the maximum number conversion is preferably from 20 to 500 nm and more preferably from 2.0 to 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the content of the pigment in the pigment dispersion is not particularly limited and can be suitably selected to suit a particular application. In terms of improving discharging stability and image density, the content is preferably from 0.1 to 50 percent by mass and more preferably from 0.1 to 30 percent by mass.

During the production, coarse particles are optionally filtered off from the pigment dispersion with a filter, a centrifuge, etc. preferably followed by degassing.

### <Resin>

The type of the resin contained in the curable composition has no particular limit and can be suitably selected to suit to a particular application. Specific examples thereof include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Particles of such resins may be also used. It is possible to mix a resin emulsion in which the resin particles are dispersed in water serving as a dispersion medium with materials such as a coloring agent and an organic solvent to obtain the curable composition. The resin particle can be synthesized or is available on the market. It is possible to synthesize the resin particle or obtain from market. These can be used alone or in combination of the resin particles.

The volume average particle diameter of the resin particle is not particularly limited and can be suitably selected to suit to a particular application. The volume average particle diameter is preferably from 10 to 1,000 nm, more preferably from 10 to 200 nm, and furthermore preferably from 10 to 100 nm to obtain good fixability and image hardness.

The volume average particle diameter can be measured by using a particle size analyzer (Nanotrac Wave-UT151, manufactured by MicrotracBEL Corp.).

The proportion of the resin is not particularly limited and can be suitably selected to suit to a particular application. In terms of fixability and storage stability of the curable composition, it is preferably from 1 to 30 percent by mass and more preferably from 5 to 20 percent by mass to the total content of the curable composition.

The particle diameter of the solid portion in the curable composition has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as image density. The solid portion includes resin particles, particles of pigments, etc. The particle diameter of the solid portion can be measured by using a particle size analyzer (Nanotrac Wave-UT151, manufactured by MicrotracBEL Corp).

### <Additive>

The curable composition may further optionally contain a surfactant, a defoaming agent, a preservative and fungicide, a corrosion inhibitor, a pH regulator, etc.

### <Surfactant>

Examples of the surfactant include, but are not limited to, silicone-based surfactants, fluorosurfactants, amphoteric surfactants, nonionic surfactants, anionic surfactants, etc.

The silicone-based surfactant has no specific limit and can be suitably selected to suit to a particular application. Among silicone-based surfactants, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These fluoro surfactants are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination.

The silicone-based surfactants have no particular limit and can be suitably selected to suit to a particular application. Specific examples thereof include, but are not limited to, side-chain-modified polydimethyl siloxane, both end-modified polydimethylsiloxane, one-end-modified poly dimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant.

Any suitably synthesized surfactant and any product thereof available on the market is suitable. Products available on the market are obtained from Byk Chemie Japan Co., Ltd., Shin-Etsu Chemical Co., Ltd., Dow Corning Toray Silicone Co., Ltd., NIHON EMSION Co., Ltd., Kyoeisha Chemical Co., Ltd., etc.

The polyether-modified silicone-based surfactant has no particular limit and can be suitably selected to suit to a particular application. Examples thereof include a compound in which the polyalkylene oxide structure represented by the following general formula S-1 is introduced into the side chain of the Si site of dimethyl polysiloxane.

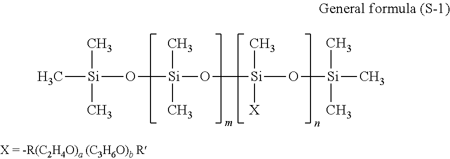

(In the general formula S-1, “m”, “n”, “a” and “b” each, respectively represent integers, R represents an alkylene group, and R′ represents an alkyl group.)

Products available on the market may be used as the polyether-modified silicone-based surfactants. Specific examples of the products available on the market include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2134, FZ-2161, FZ-2162, FZ-2163, and FZ-2164 tall manufactured by Dow Corning Toray Silicone Co., Ltd.), BYK-33 and BYK-387 (both manufactured by Byk Chemie Japan Co., Ltd.), and TSF4440, TSF4452, and TSF4453 manufactured by Toshiba Silicone Co., Ltd.).

A fluorosurfactant in which the number of carbon atoms replaced with fluorine atoms is from 2 to 16 and more preferably from 4 through 16 is preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these fluorosurfactants, polyoxyalkylene ether polymer compounds having a perfluoroalkyl ether group in its side chain are preferable because they do not foam easily and the fluorosurfactant represented by the following general formula F-1 or general formula F-2 is particularly preferable.

CF₃CF₂(CF₂CF₂)ₘ—CH₂CH₂O(CH₂CH₂O)ₙH General formula (F-1)

In general formula F-1, “m” is preferably 0 or an integer of from 1 to 10 and “n” is preferably 0 or an integer of from 1 to 40 in order to provide water solubility

CₙF₂ₙ₊₁—CH₂CH(OH)CH₂—O—(CH₂CH₂O)ₐ—Y General formula (F-2)

In general formula F-2, Y represents H, CₙF₂ₙ₊₁, where “n” is an integer of from 1 to 6, CH₂CH(OH)CH₂—CₙF₂ₙ₊₁, where n represents an integer of from 4 to 6, or CₚH₂ₚ₊₁, where p represents an integer of from 1 to 19. “a” represents an integer of from 4 to 14.

Products available on the market may be used as the fluorosurfactant. Specific examples of the products available on the market include, but are not limited to, SURFLON S-111, SURFLON S-112, SURFLON S-113, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFAC F-470, F-1405, and F-474 (all manufactured by DIC CORPORATION); ZONYL™ TBS, FSP, FSA, FSN-100, FSN, FSO-100, FSO, FS-300, and UR, (all manufactured by Du Pont K.K.); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.), and UNIDYNE DSN-403N (manufactured by DAIKIN INDUSTRIES). Of these products, FS-300 (manufactured by Du Pont K.K.), FT 110, FT-250, FT-251, FT-400S, FT-150, and FT-400SW (all manufactured by NEOS COMPANY LIMITED), POLYFOX PF-151N (manufactured by OMNOVA SOLUTIONS INC.), and UNIDYNE ISSN-403N (manufactured by DAIKIN INDUSTRIES) are particularly preferable in terms of good printing quality, coloring in particular, and improvement on permeation, wettability, and uniform dyeing property to paper.

The proportion of the surfactant in the curable composition is not particularly limited and can be suitably selected to suit to a particular application. It is preferably from 0.001 to 5 percent by mass and more preferably from 0.05 to 5 percent by mass in terms of excellent wettability and discharging stability and improvement on image quality.

### <Other Components>

The curable composition of the present disclosure optionally contains other known components. The other known components are not particularly limited. Specific examples thereof include, but are not limited to, known articles such as surfactants, polymerization inhibitors, leveling agents, defoaming agents, fluorescent brighteners, permeation enhancing agents, wetting agents (humectants), fixing agents, viscosity stabilizers, fungicides, preservatives, antioxidants, ultraviolet absorbents, chelate agents, pH adjusters, (regulators), and thickeners.

### <Defoaming Agent>

The defoaming agent has no particular limit. For example, silicone-based defoaming agents, polyether-based defoaming agents, and aliphatic acid ester-based defoaming agents are suitable. These defoaming agents can be used alone or in combination. Of these defoaming agents, silicone-based defoaming agents are preferable to easily break foams.

### <Preservatives and Fungicides>

The preservatives and fungicides are not particularly limited. A specific example is 1,2-benzisothiazolin-3-on.

### <Corrosion Inhibitor>

The corrosion inhibitor has no particular limit. Examples thereof are acid sulfite and sodium thiosulfate.

### <Curing Unit>

The curable composition of the present disclosure is cured by irradiation with ultraviolet rays from a light-emitting diode having a peak illuminance in a wavelength range of from 265 nm through 300 nm.

The maximum illuminance on a printing medium may be, for example, from 100 mJ/cm² through 1,000 mJ/cm², and is preferably from 100 mJ/cm² through 500 mJ/cm².

In terms of beading, it is preferable to irradiate the curable composition with ultraviolet rays for an irradiation time of from 0.1 sec through 0.6 sec after the curable composition is discharged on a printing medium.

### <Preparation of Curable Composition>

The curable composition of the present disclosure can be prepared by using the components described above. The preparation devices and conditions are not particularly limited. For example, the curable composition can be prepared by subjecting water, a polymerizable compound, a pigment, a dispersant, etc., to a dispersion treatment using a dispersing machine such as a ball mill, a kitty mill, a disk mill, a pin mill, and a DYNO-MILL to prepare a pigment liquid dispersion, and further mixing the pigment liquid dispersion with a polymerizable compound, a water-soluble polymerization initiator, a polymerization inhibitor, and a surfactant.

### <Viscosity>

The viscosity of the curable composition of the present disclosure has no particular limit because it can be adjusted depending on the purpose and application devices. For example, if an ejecting device that ejects the composition from nozzles is employed, the viscosity thereof is preferably in the range of 3 mPa·s to 40 mPa·s, more preferably 5 mPa·s toy 15 mPa·s, and particularly preferably 6 mPa·s to 12 mP·s in the temperature range of 20 degrees C. to 65 degrees C., preferably at 2.5 degrees C. In addition, it is particularly preferable to satisfy this viscosity range by the composition free of the organic solvent described above. Incidentally, the viscosity can be measured by a cone plate rotary viscometer (VISCOMETER TVE-22L manufactured by TOM SANGYO CO., LTD.) using a cone rotor (1°34×R24) at a number of rotation of 50 rpm with a setting of the temperature of hemathermal circulating water in the range of 20 degrees C. to 65 degrees C. VISCOMATE VM-150III can be used for the temperature adjustment of the circulating water.

### <Application Field>

The application field of the curable composition of the present disclosure is not particularly limited. It can be applied to any field where ultraviolet-ray-curable compositions are used. For example, the curable composition is selected to a particular application and used for a resin for processing, a paint, an adhesive, an insulant, a releasing agent, a coating material, a sealing material, various resists, and various optical materials.

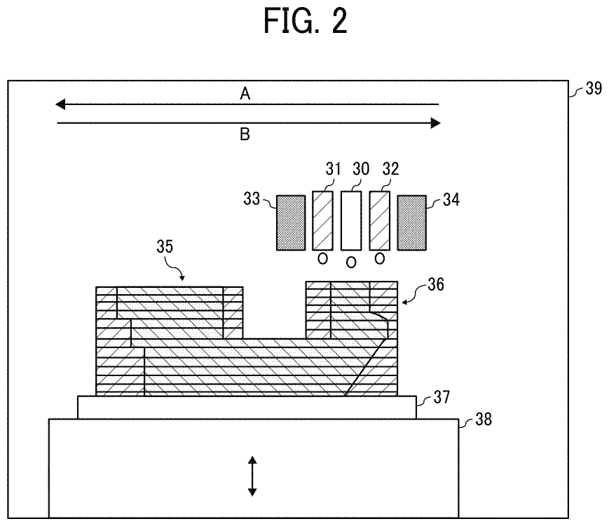

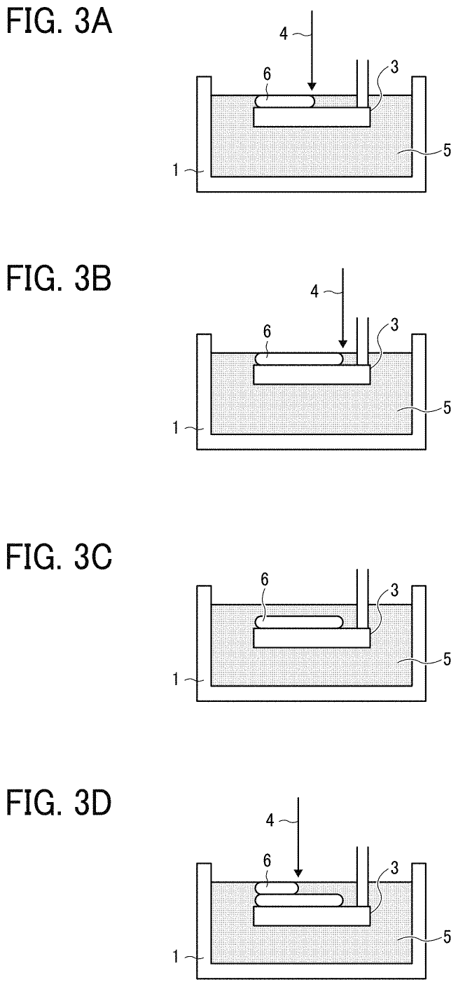

Furthermore, the curable composition of the present disclosure can be used as an ink to form two-dimensional texts, images, and designed coating film on various substrates and in addition as a solid object forming material to form a three-dimensional object. This three dimensional object forming material may also be used as a binder for powder particles used in a powder layer laminating method of forming a three-dimensional object by repeating curing and layer-forming of powder layers, and as a three-dimensional object constituent material (a model material) and a supporting member (support material) used in an additive manufacturing method (a stereolithography method) as illustrated in FIG. 2 and FIGS. 3A to 3D. FIG. 2 is a diagram illustrating a method of additive manufacturing to sequentially form layers of the curable composition of the present disclosure one on top of the other by repeating discharging the curable composition to particular areas followed by curing upon irradiation of ultraviolet rays (described in detail below). FIGS. 3A to 3D are diagrams illustrating a method of additive manufacturing to sequentially form cured layers 6 having respective predetermined forms one on top of the other on a movable stage 3 by irradiating a storing pool (storing part) 1 of the curable composition 5 of the present disclosure with the ultraviolet rays 4.

An apparatus for fabricating a three-dimensional object by the curable composition of the present disclosure is not particularly limited and can be a known apparatus. For example, the apparatus includes a containing device, a supplying device, and a discharging device of the curable composition, and an ultraviolet ray irradiator.

In addition, the present disclosure includes cured materials obtained by curing the curable composition and processed products obtained by processing structures having the cured materials on a substrate. The processed product is fabricated by, for example, heat-drawing and punching a cured material or structure having a sheet-like form or film-like form. Examples thereof include, but are not limited to, products that need processing of the surface after decoration, such as gauges or operation panels of vehicles, office machines, electric and electronic machines, and cameras.

The substrate is not particularly limited. It can suitably be selected to a particular application. Examples thereof include paper, thread, fiber, fabrics, leather, metal, plastic, glass, wood, ceramic, or composite materials thereof. Of these, plastic substrates are preferred in terms of processability.

### <Print Medium>

The print medium for use in printing is not particularly limited. Specific examples thereof include, but are not limited to, plain paper, gloss paper, special paper, cloth, film, OHP sheets, printing paper for general purpose.

### <Stored Container>

The stored container of the present disclosure contains the curable composition and is suitable for the applications as described above. For example, if the curable composition of the present disclosure is used for ink, a container that stores the ink can be used as an ink cartridge or an ink bottle. Therefore, users can avoid direct contact with the ink during operations such as transfer or replacement of the ink, so that fingers and clothes are prevented from contamination. Furthermore, inclusion of foreign matters such as dust in the ink can be prevented. In addition, the container can be of any size, any form, and any material. For example, the container can be designed to a particular application. It is preferable to use a light blocking material to block the light or cover a container with a light blocking sheet, etc.

### <Image Forming Method and Image Forming Apparatus>

The image forming method of the present disclosure includes a light-entitling diode (LED) having a peak illuminance in a wavelength range of from 26.5 nm through 300 nm as an irradiator to irradiate the curable composition of the present disclosure with ultraviolet rays and a storing part containing the curable composition of the present disclosure or an ink. The storing part may include the container mentioned above. Furthermore, the method and the apparatus may respectively include a discharging step and a discharging device to discharge the curable composition. The method of discharging the curable composition is not particularly limited, and examples thereof include, but are not limited to, a continuous jetting method and an on-demand method. The on-demand method includes, but is not limited to, a piano method, a thermal method, an electrostatic method, etc.

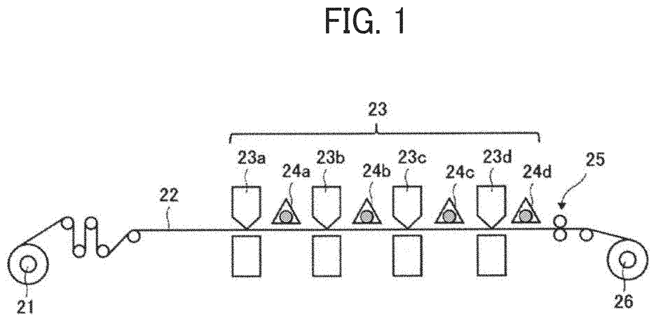

FIG. 1 is a diagram illustrating a two-dimensional image forming apparatus equipped with an inkjet discharging device. Printing units 23a, 23b, 23c, and 23d respectively having ink cartridges and discharging heads for yellow, magenta, cyan, and black curable inks discharge the inks onto a printing medium 22 fed from a supplying roller 21. Thereafter, light sources 24a, 24b, 24c, and 24d configured to cure the inks emit ultraviolet rays to the inks, thereby curing the inks to form a color image. It is preferable to provide a distance between the discharging heads and the light sources in order to adjust the time until irradiation with ultraviolet rays. The distance is preferably from 10 cm through 200 cm, and more preferably from 30 cm through 100 cm. This distance is effective for controlling beading.

Thereafter, the printing medium 22 is conveyed to a processing unit 25 and a printed matter reeling roll 26. Each of the printing unit 23a, 23b, 23c and 23d may have a heating mechanism to liquidize the ink at the ink discharging portion. Moreover, in another embodiment of the present disclosure, a mechanism may optionally be included to cool down the printing medium to around room temperature in a contact or non-contact manner. In addition, the inkjet printing method may be either of serial methods or line methods. The serial methods include discharging an ink onto a printing medium by moving the head while the printing medium intermittently moves according to the width of a discharging head. The line methods include discharging an ink onto a printing medium from a discharging head held at a fixed position while the printing medium continuously moves.

The printing medium 22 is not particularly limited. Specific examples thereof include, but are not limited to, paper, film, ceramics and glass, metal, or complex materials thereof. The printing medium 22 takes a sheet-like form but is not limited thereto. The image forming apparatus may have a one-side printing configuration and/or a two-side printing configuration. The printing medium is not limited to articles used as typical printing media. It is suitable to use cardboard, building materials such as wall paper and floor material, concrete, cloth for apparel such as T-shirts, textile, and leather as the printing medium.

Optionally, multiple colors can be printed with nor or weak ultraviolet ray from the light sources 24a, 24b, and 24c followed by irradiation of the ultraviolet ray from the light source 24d. As a result, energy and cost can be saved.

The printed matter having images printed with the curable composition of the present disclosure includes articles having printed images or texts on a plain surface of conventional paper, resin film, etc., a rough surface, or a surface made of various materials such as metal or ceramic. In addition, by laminating layers of images in part or the entire of a printing medium, a partially stereoscopic image (formed of two dimensional part and three-dimensional part) and a three dimensional objects can be fabricated.

FIG. 2 is a schematic diagram illustrating another example of the image forming apparatus (apparatus to fabricate a 3D object) of the present disclosure. An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first curable composition, and ejection head units 31 and 32 for support and curing these compositions eject a second curable composition having a different composition from the first curable composition, while ultraviolet irradiators 33 and 34 adjacent to the ejection head units 31 and 32 cure the compositions. To be more specific, for example, after the ejection head units 31 and 32 for support eject the second curable composition onto a substrate 37 for additive manufacturing and the second curable composition is solidified by irradiation of ultraviolet rays to form a first substrate layer having a space for composition, the ejection head unit 30 for additive manufacturing ejects the first curable composition onto the pool followed by irradiation of ultraviolet rays for solidification, thereby forming a first additive manufacturing layer. This step is repeated multiple times lowering the stage 38 movable in the vertical direction to laminate the supporting layer and the additive manufacturing layer to fabricate a solid object 35. Thereafter, an additive manufacturing support 36 is removed, if desired. Although only a single ejection head unit 30 for additive manufacturing is provided to the image forming apparatus illustrated in FIG. 2, it can have two or more units 30.

### (Ink)

An ink of the present disclosure is formed of the curable composition of the present disclosure.

### (Cured Product)

A cured product of the present disclosure is formed using at least one of the curable composition of the present disclosure and the ink of the present disclosure.

### <Printed Matter>

An ink printed matter of the present disclosure includes a printing medium and an image formed on the printing medium with the ink of the present disclosure.

An inkjet printing device and an inkjet printing method are used to print the image on the printing medium to obtain the printed matter.

Image forming, printing, printing, etc. in the present disclosure represent the same meaning.

Printing media, media, and printed matters represent the same meaning.

### EXAMPLES

The present disclosure will be described below by way of Examples. The present disclosure should not be construed as being limited to these Examples,

### —Cyan Pigment Dispersion Liquid Preparation Example—

A 1 L flask equipped with a mechanical stirrer, a thermometer, a nitrogen gas introducing pipe, a reflux condenser, and a dropping funnel was internally sufficiently purged with a nitrogen gas. Subsequently, styrene (11.2 parts by mass), acrylic acid (2.8 parts by mass), lauryl methacrylate (12.0 parts by mass), polyethylene glycol methacrylate (4.0 parts by mass), styrene macromer (4.0 parts by mass), and mercaptoethanol (0.4 parts by mass) were mixed in the flask and the temperature of the mixture was raised to 65 degrees C. Next, a mixture solution obtained by mixing, styrene (100.8 parts by mass), acrylic acid (25.2 parts by mass), lauryl methacrylate (108.0 parts by mass), polyethylene glycol methacrylate (36.0 parts by mass), hydroxyl ethyl methacrylate (60.0 parts by mass), styrene macromer (36.0 parts by mass), mercaptoethanol (3.6 parts by mass), azobismethylvaleronitrile (2.4 parts by mass), and methyl ethyl ketone (18 parts by mass) was dropped into the flask for 2.5 hours. After dropping, a mixture solution of azobismethylvaleronitrile (0.8 parts by mass) and methyl ethyl ketone (18 parts by mass) was dropped into the flask for 0.5 hours. After the resultant was aged at 65 degrees C. for 1 hour, azobismethylvaleronitrile (0.8 parts by mass) was added to the resultant, which was further aged for 1 hour. After the reaction was completed, methyl ethyl ketone (364 parts by mass) was added into the flask, to obtain a polymer solution A (800 parts by mass) having a concentration of 50% by mass.

Next, the obtained polymer solution A (28 parts by mass), a phthalocyanine pigment (obtained from Dainichiseika Color & Chemicals Mfg. Co., Ltd., CHROMOFINE BLUE A-220JC) (26 parts by mass), a 1 mol/L potassium hydroxide aqueous solution (13.6 parts by mass), methyl ethyl ketone (20 parts by mass), and ion-exchanged water (13.6 parts by mass) were sufficiently stirred, and subsequently kneaded using a roll mill, to obtain a paste. The obtained paste was added into pure water (200 parts by mass) and sufficiently stirred. Subsequently, methyl ethyl ketone and water were evaporated from the resultant using an evaporator, and the obtained dispersion liquid was subjected to pressure filtration through a polyvinylidene fluoride membrane filter having an average pore diameter of 5.0 micrometers to remove coarse particles, to obtain a pigment-containing polymer particle dispersion liquid containing a pigment by 15% by mass and a solid component by 20% by mass. The average particle diameter (D₅₀) of the polymer particles in the obtained pigment dispersion liquid was measured. The average particle diameter (D₅₀) measured with a particle size distribution measuring instrument (obtained from Nikkiso Co., Ltd., NANOTRAC UPA-EX150) was 56.0 nm.

### Example 1

### —Preparation of Inkjet Ink 1—

Water-soluble organic solvents (humectants) presented in Table 1 below and water were mixed, and stirred for 1 hour, to obtain a uniform mixture. Polymerizable compounds were added to the resultant and stirred for 1 hour, and the pigment dispersion liquid, a water-soluble polymerization initiator, and a surfactant were added to the resultant and stirred for 1 hour. This dispersion liquid was subjected to pressure filtration through a polyvinylidene fluoride membrane filter having an average pore diameter of 5.0 micrometers to remove coarse particles and dust, to produce an inkjet ink 1.

### Examples 2 to 6

—Preparation of inkjet inks 2 to 6—

Inkjet inks 2 to 6 were obtained in the same manner as in Example 1, except that unlike in Example 1, the composition was changed to as presented in Table 1.

Next, “dischargeability”, “beading”, and “scratch resistance” of the obtained inkjet inks (Experiment No. 1 to 9) were measured and evaluated in the manners described below. The results are presented in Table 2.

### <Printing Apparatus>

A single-pass printer mounted with a head MH5220 obtained from Ricoh Company, Ltd. was produced, and a solid image chart was printed. In the single-pass printer, a UV-LED lamp in which hermetic SMDs having local maximum wavelengths at 265 nm, 285 nm, and 325 nm respectively were arranged was installed at a position of 50 cm from the head, and a hot air drier was installed at a position of 150 cm from the head, so that the printer would be able to perform UV irradiation while doing printing. The printing conditions include a head gap of 2 mm, a discharging amount of 16 pl per droplet, 600 dpi, and an amount of ink to be attached of 8.9 g/m². The image pattern was printed as a solid image of 5 cm×20 cm.

Under environmental conditions adjusted to 23±0.5 degrees C. and 50±5% RH, the driving voltage of a piezo element of the inkjet printing apparatus was varied to set the inkjet printing apparatus to be able to attach an ink in the same amount on a commercially available PET film (with a film thickness of 100 micrometers).

By varying the medium conveying speed, it would be possible to adjust the integrated UV light quantity arbitrarily. The illuminance was measured using UV POWERPACK II obtained from Heraeus K.K. The time from discharging of ink droplets until UV irradiation was 0.5 sec. The distance between the inkjet ink discharging head and an irradiator configured to emit ultraviolet rays from a light-emitting diode was set to 50 cm.

### <Dischargeability>

The obtained inkjet ink was discharged continuously for 2 minutes from the inkjet discharging apparatus mounted with the MH5220 head (obtained from Ricoh Company, Ltd.), to confirm that the ink was discharged from all nozzles. Subsequently, after the inkjet discharging apparatus was left to stand still for 5 minutes, the number of nozzles that would become unable to discharge through ink discharging of a thousand times was counted, to evaluate “dischargeability” according to the evaluation criteria described below A and B are pass levels.

The inkjet discharging apparatus was set to a driving frequency of 18 kHz, a heating temperature of 25 degrees C., and an ink discharging amount of 15 pL per shot.

### [Evaluation Criteria]

A: Three or less

B: Four or more but less than 20

C: Twenty or more

### <Beading Evaluation>

A solid image of 5 cm×20 cm was printed using the single-pass printer mounted with the head MH5220 obtained from Ricoh Company, Ltd, and presence or absence of color variation in the image was evaluated as beading. A and B are pass levels.

### [Evaluation Criteria]

A: No beading was observed.

B: Beading was slightly observed, butt was non-problematic (i.e., could not be recognized when moved away by 1 m).

C: A heavy beading was observed (i.e., could be recognized even when moved away by 1 m).

### <Scratch Resistance>

A solid image of 5 cm×20 cm was printed using the single-pass printer mounted with the head MH5220 obtained from Ricoh Company, Ltd., and dried with hot air for 30 sec using PLAJET obtained from Ishizaki Electric Mfg. Co., Ltd. from a position apart by 20 cm. Next, the produced cured product and standard adjacent fabric for test (shirting No. 3) compliant with JIS L 0803 were set in a rubbing fastness tester RT-300 (obtained from Daiei Kagaku Seiki MFG. Co., Ltd., an instrument compliant with a rubbing tester Type II (Gakushin-Type) specified in dyed color fastness test method (JIS L-0849)), and a loading weight (500 g) was also set in the tester. Then, the cured product was reciprocally rubbed a hundred times. The density on the cotton fabric after the test was measured with EXACT SCAN (obtained from X-Rite Inc.), and the density difference with respect to an untested cotton fabric was evaluated. The measurement was evaluated according to the evaluation criteria described below. A and B are pass levels.

### [Evaluation Criteria]

A: 0.02 or less

B: Greater than 0.02 but 0.2 or less

C: Greater than 0.2

TABLE 1

| | | | Ink No. | | | | | |
|---|---|---|---|---|---|---|---|---|
| | | | 1 | 2 | 3 | 4 | 5 | 6 |
| | | | Example | | | | | |
| | | | Ex. 1 | Ex. 2 | Ex. 3 | Ex. 4 | Ex. 5 | Ex. 6 |
| Water-soluble polymerization initiator | | 2-hydroxy-2- | 0.5% | 1.2% | 0.8% | 0.8% | 0.5% | 0.7% |
| | | methyl-1-phenylpropanane | | | | | | |
| Polymerizable | Monomer | N,N′-Methylene | 7.0% | 5.0% | 8.0% | | 20.0% | 10.0% |
| compound | | bismethacrylamide | | | | | | |
| | Reactive urethane | LAROMER | 7.0% | 5.0% | 2.0% | 10.0% | | 20.0% |
| | dispersion | UA8983 | | | | | | |
| Water-soluble | | 12-Propanediol | 14.0% | 14.0% | 19.0% | 19.0% | 10.0% | 0.0% |
| organic solvent | | 3-Methoxy-N,N-dimethyl | 14.0% | 14.0% | 14.0% | 14.0% | 14.0% | 14.0% |
| | | propionamide | | | | | | |
| | | 3-Methoxy-1-butanol | 3.0% | 3.0% | 3.0% | 3.0% | 3.0% | 3.0% |
| Surfactant | | SURFYNOL 440 | 1.0% | 1.0% | 1.0% | 1.0% | 1.0% | 1.0% |
| Pigment dispersion liquid | | Cyan pigment dispersion | 1.8% | 1.8% | 1.8% | 1.8% | 1.8% | 1.8% |
| | | liquid | | | | | | |
| Water | | | 51.7% | 56.2% | 51.2% | 51.2% | 50.2% | 50.2% |
| | | Total (% by mass) | 100.0% | 100.0% | 100.0% | 100.0% | 100.0% | 100.0% |

| | | | | | | | |
|---|---|---|---|---|---|---|---|
| Water-soluble polymerization | (% by mass) | 0.5% | 1.2% | 0.8% | 0.8% | 0.5% | 0.7% |
| initiator content in ink | | | | | | | |
| Water content in ink | (% by mass) | 51.7% | 56.2% | 51.2% | 51.2% | 50.2% | 50.2% |
| Polymerizable compound content in ink | (% by mass) | 14.0% | 10.0% | 10.0% | 10.0% | 20.0% | 30.0% |
| Water-soluble polymerization initiator/ | | 0.036 | 0.120 | 0.080 | 0.080 | 0.025 | 0.023 |
| polymerizable compound | | | | | | | |

TABLE 2

| | | Illuminance (mJ/cm2) | | | Evaluation result | | |
|---|---|---|---|---|---|---|---|
| Experiment | Ink | UV-LED peak | UVB | UVA | | Scratch | |
| No. | No. | illuminance | 280 nm-320 nm | 320 nm to 390 nm | Dischargeability | resistance | Beading |
| 1 | 1 | LED 285 nm | 100 | 0 | A | A | B |
| 2 | 2 | LED 285 nm | 100 | 0 | A | A | B |
| 3 | 3 | LED 285 nm | 100 | 0 | A | A | B |
| 4 | 4 | LED 285 nm | 100 | 0 | A | A | B |
| 5 | 5 | LED 285 nm | 100 | 0 | B | A | B |
| 6 | 6 | LED 285 nm | 100 | 0 | B | A | C |
| 7 | 3 | LED 365 nm | 0 | 100 | A | C | C |
| 8 | 3 | LED 325 nm | 100 | 0 | A | C | C |
| 9 | 3 | LED 285 nm | 100 | 0 | A | A | B |

From the results of Tables 1 and 2, it was revealed that Examples in which the inks prepared in the Examples were used and cured by irradiation with ultraviolet rays emitted from a light-emitting diode having a peak illuminance in a wavelength range of from 265 nm through 300 nm were excellent in dischargeability and impartment of scratch resistance and anti-beading.

The details of the components presented in Table 1 are as follows.

2-hydroxy-2-methyl-1-phenylpropanone: a hydroxyacetophenone-based water-soluble polymerization initiator

N,N′-Methylenebismethacrylamide: a water-soluble monomer

LAROMER LR8983: a reactive urethane dispersion (obtained from BASF GmbH) (the solid content thereof is presented in Table 1)

SURFYNOL 440: a surfactant (obtained from Nissin Chemical Co., Ltd.)

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An inkjet printing method comprising
irradiating a curable composition with ultraviolet rays emitted from a light-emitting diode having a peak illuminance in a wavelength range of from 265 nm through 300 nm to cure the curable composition,
wherein the curable composition contains water, a polymerizable compound, and a water-soluble polymerization initiator having local absorption maximum in a wavelength range of 300 nm or shorter, and a mass content of the water is higher than a mass content of the polymerizable compound and the mass content of the polymerizable compound is higher than a mass content of the water-soluble polymerization initiator.

2. The inkjet printing method according to claim 1,
wherein the mass content of the water is 50% b mass or greater, the mass content of the polymerizable compound is 10% by mass or greater, and the mass content of the water-soluble polymerization initiator by 0.5% by mass or greater.

3. The inkjet printing method according to claim 1,
wherein a ratio between the water-soluble polymerization initiator and the polymerizable compound expressed as a mass ratio of the water-soluble polymerization initiator:the polymerizable compound is from 1:8 through 1:40.

4. The inkjet printing method according to claim 1,
wherein the mass content of the polymerizable compound is 10% by mass or greater but 20% by mass or less.

5. The inkjet printing method according to claim 1,
wherein the polymerizable compound contains polymer particles containing a polymerizable group.

6. The inkjet printing method according to claim 1, wherein the irradiating includes irradiating the curable composition with the ultraviolet rays for an irradiation time of from 0.1 sec through 0.6 sec after discharging the curable composition on a print medium.

7. The inkjet printing method according to claim 1, further comprising
providing a distance between a discharging head configured to discharge the curable composition and an irradiator configured to emit the ultraviolet rays from the light-emitting diode, in order to adjust a time until irradiation with the ultraviolet rays.

8. A curable composition comprising:
water;
a polymerizable compound; and
a water-soluble polymerization initiator having local absorption maximum at a wavelength of 300 inn or shorter,
wherein a mass content of the water is higher than a mass content of the polymerizable compound and the mass content of the polymerizable compound is higher than a mass content of the water-soluble polymerization initiator.

9. An ink comprising
the curable composition according to claim 8.

10. A stored container comprising
the curable composition according to claim 8; and
a container storing the curable composition.

11. A two-dimensional or three-dimensional image forming apparatus comprising:
a storing part storing the curable composition according to claim 8 in a container; and
an irradiator configured to emit ultraviolet rays from a light-emitting diode having a peak illuminance in a wavelength range of from 265 nm through 300 nm,
wherein the two-dimensional or three-dimensional image forming apparatus performs the inkjet printing method according to claim 1.
